(19) United States
(12) Patent Application Publication
(10) Pub. No.: US 2006/0163505 A1
(43) Pub. Date: Jul. 27, 2006

(54) Radiation image information reading apparatus

(75) Inventor: Kenji Tajima, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/390,297

(22) Filed: Mar. 28, 2006

Related U.S. Application Data
(62) Division of application No. 09/795,197, filed on Mar. 1, 2001.

(30) Foreign Application Priority Data
Mar. 1, 2000 (JP) 2000-056429
Mar. 1, 2000 (JP) 2000-056430

(51) Int. Cl. G03B 42/08

(52) U.S. Cl. 250/588; 250/589; 250/584

(57) ABSTRACT

An apparatus housing and a controller are separate from each other, and opposite sides of a second casing of the apparatus housing have respective first and second cable ports defined therein for extending a cable connected to the controller. With the cable extended through the first cable port or the second cable port, the layout of the apparatus housing and the controller can easily be changed. Therefore, the apparatus housing and the controller can be installed in any of various layout patterns.

### BACKGROUND OF THE INVENTION

1. Field of the Invention

The present invention relates to a radiation image information reading apparatus for reading radiation image information of a subject using a stimulable phosphor sheet.

2. Description of the Related Art

There is known a system for recording radiation image information of a subject such as a human body with a stimulable phosphor, and reproducing the recorded radiation image information on a photosensitive medium such as a photographic film, or displaying the recorded radiation image information on a display device such as a CRT or the like.

When a radiation energy such as X-rays, α-rays, γ-rays, electron beams, ultraviolet radiation, or the like is applied to a certain phosphor, it stores part of the applied radiation energy. When stimulating light such as visible light is subsequently applied to the phosphor, the phosphor emits light depending the stored radiation energy. Such a phosphor is referred to as a stimulable phosphor. A stimulable phosphor is usually used in the form of a sheet which is referred to as a stimulable phosphor sheet, for the ease with which it can be handled.

The above known system comprises a built-in radiation image information reading apparatus which includes a recording section for temporarily recording radiation image information of a subject on a stimulable phosphor sheet, a reading section for photoelectrically reading the radiation image information recorded on the stimulable phosphor sheet by applying simulating light to the stimulable phosphor sheet, and an erasing section for erasing remaining radiation image information from the stimulable phosphor sheet after the recorded radiation image information has been read, the stimulable phosphor sheet being circulated or moved back and forth in the apparatus.

The known system alternatively comprises a radiation image information reading apparatus which includes a loading section for loading a cassette or magazine which houses a stimulable phosphor sheet which bears recorded radiation image information of a subject, a reading section for photoelectrically reading the radiation image information from the stimulable phosphor sheet that has been removed from the cassette by applying stimulating light to the stimulable phosphor sheet, and an erasing section for erasing remaining radiation image information from the stimulable phosphor sheet after the radiation image information has been read from the stimulable phosphor sheet.

One known type of the built-in radiation image information reading apparatus has an imaging bed that is horizontally movable. For example, as shown in FIG. 8 of the accompanying drawings, a conventional radiation image information reading apparatus 1 has a housing 2 and an imaging bed 3 floatingly supported on the top of the housing 2 for movement along two horizontal axes, i.e., X- and Y-axes. A patient 4, who is a subject to be imaged, lies on the imaging bed 3, with the back down, as shown, or one side down.

The operator 5 moves the imaging bed 3 along the X-axis or the Y-axis to bring a desired imaging area of the patient 4 into registration with the X-ray applying position of an X-ray radiating unit 6. Then, the operator 5 energizes the X-ray radiating unit 6 to capture radiation image information of the desired imaging area of the patient 4.

The height H of the imaging bed 3 is set to a vertical position that is suitable for the operator 5 to operate the radiation image information reading apparatus 1 efficiently. If the patient 4 is of a small height, then the operator 5 needs to provide a step for the patient 4 to use because the patient 4 would otherwise find it difficult to climb on the imaging bed 3. Furthermore, if the patient 4 is delivered on a wheelchair or a stretcher, then it is highly laborious and time-consuming to transfer the patent 4 from the wheelchair or the stretcher onto the imaging bed 3.

One solution is to divide the radiation image information reading apparatus 1 into a control unit and a recording unit thereby to effectively lower the height of the imaging bed 3. If the radiation image information reading apparatus 1 is divided into the two parts, then a connection cable needs to interconnect those two parts. Since such a connection cable presents an obstacle, it restricts the installation of the radiation image information reading apparatus 1 to certain limited areas particularly in hospitals.

Another problem that has been pointed out in the art with respect to the radiation image information reading apparatus 1 is that images that are read from stimulable phosphor sheets suffer certain faults due to dust that has entered the reading section via a feed system or dust that has been attached to the stimulable phosphor sheets. In addition, the read images may be caused to blur owing to vibrations transmitted from the feed system to the reading section.

### SUMMARY OF THE INVENTION

It is therefore an object of the present invention to provide a radiation image information reading apparatus which takes up a reduced installation space and can lend itself to various layout patterns.

A major object of the present invention is to provide a radiation image information reading apparatus which is constructed to prevent dust from entering a reading unit for thereby allowing the reading unit to read high-quality radiation image information.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a radiation image information reading apparatus according to the present invention;

FIG. 2 is a schematic side elevational view showing an internal structure of the radiation image information reading apparatus;

FIG. 3 is a perspective view of an internal structure of a first casing and an imaging bed of the radiation image information reading apparatus;

FIG. 4 is a perspective view of a stimulable phosphor sheet;

FIG. 5 is a cross-sectional view of the radiation image information reading apparatus;

FIG. 6 is a plan view of a layout pattern of a housing, a controller, and a switch unit of the radiation image information reading apparatus;

FIG. 7 is a plan view of another layout pattern of the housing, the controller, and the switch unit of the radiation image information reading apparatus; and

FIG. 8 is a perspective view of a conventional radiation image information reading apparatus.

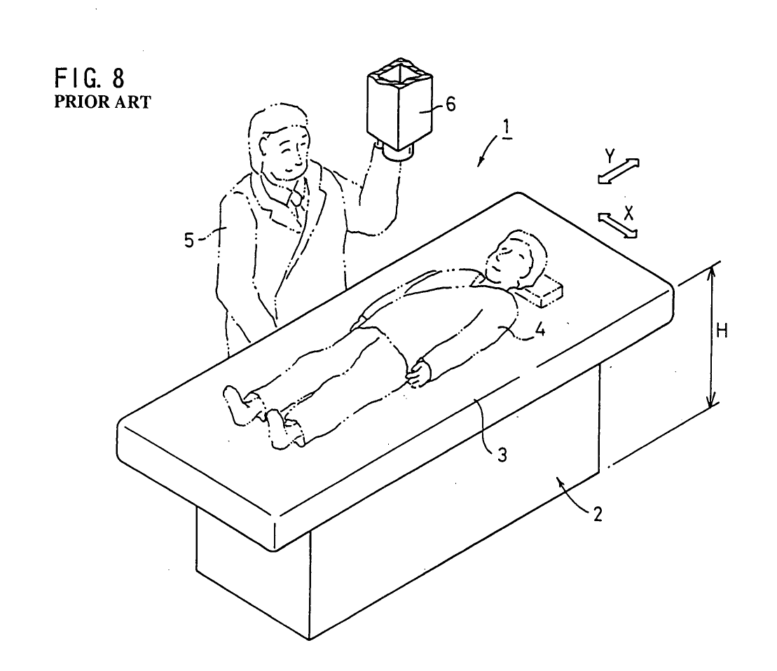

### DESCRIPTION OF THE PREFERRED EMBODIMENT

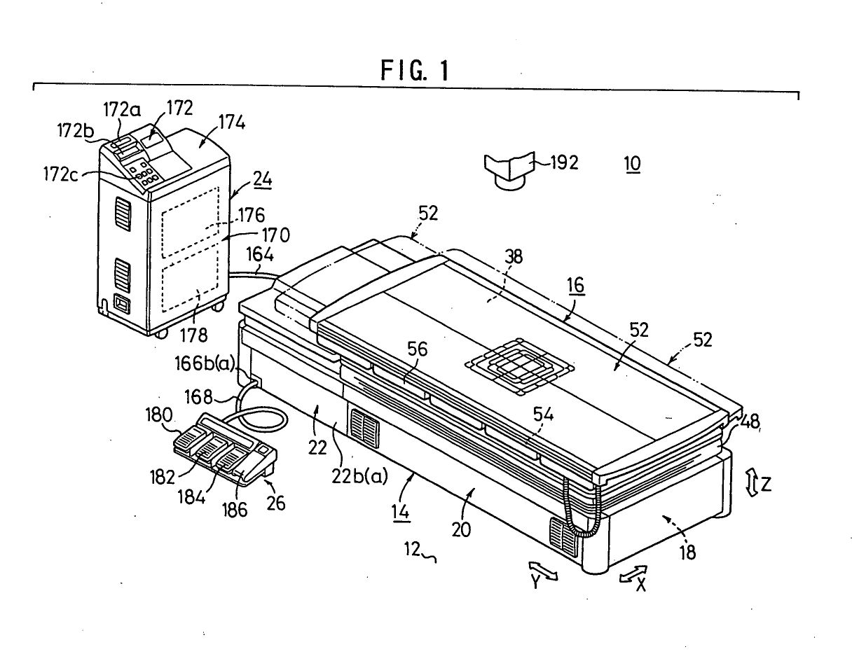

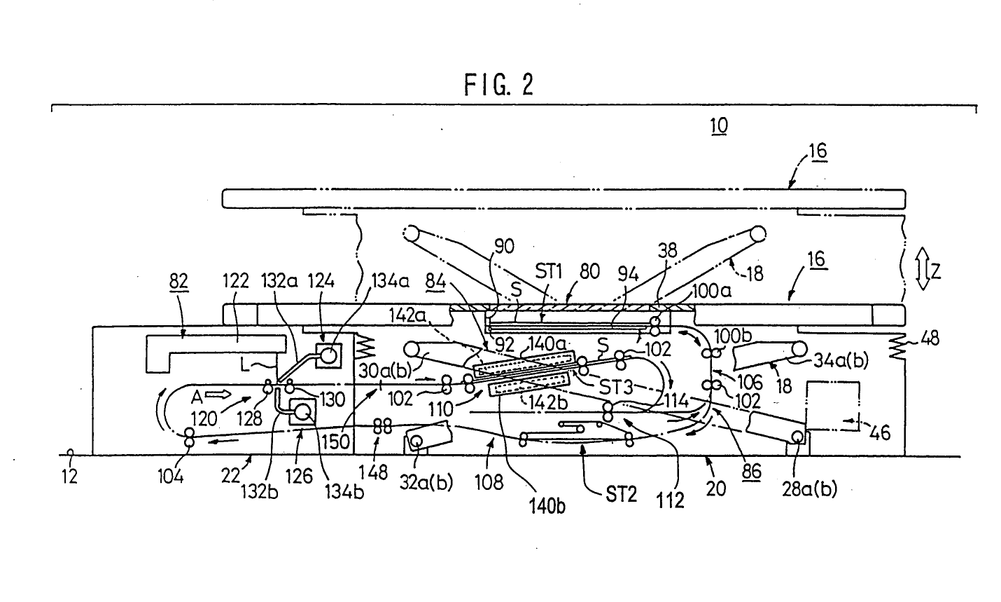

As shown in FIGS. 1 and 2, a radiation image information reading apparatus 10 according to the present invention comprises an apparatus housing 14 placed on a floor or installation surface 12, an imaging bed 16 for supporting a patient, with the back or one side down, directly thereon, and a lifting/lowering mechanism 18 for lifting and lowering the imaging bed 16 with respect to the apparatus housing 14. The apparatus housing 14 comprises a first casing 20 housing the lifting/lowering mechanism 18 therein and a second casing 22 separate from and adjacent to the first casing 20. A controller 24 and a switch unit 26 are connected to the second casing 22.

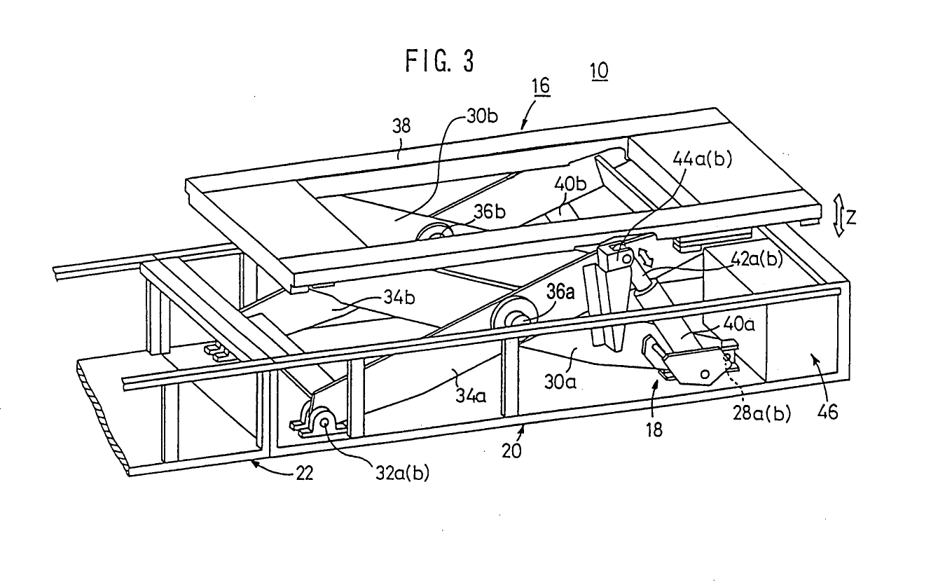

As shown in FIGS. 2 and 3, the lifting/lowering mechanism 18 comprises a pair of horizontally spaced first swing arms 30a, 30b swingably supported on one end of the first casing 20 remote from the second casing 22 by respective pivot shafts 28a, 28b, and a pair of horizontally spaced second swing arms 34a, 34b swingably supported on the opposite end of the first casing 20 close to the second casing 22 by respective pivot shafts 32a, 32b. The first and second swing arms 30a, 34a and the first and second swing arms 30b, 34b are coupled to each other by respective joint shafts 36a, 36b at substantially central regions thereof. The first swing arms 30a, 30b and the second swing arms 34a, 34b have respective distal ends held in operative engagement with the bottom of a vertically movable base 38 of the imaging bed 16.

Hydraulic cylinders 40a, 40b are mounted respectively on the first swing arms 30a, 30b near the pivot shafts 28a, 28b and have respective rods 42a, 42b extending toward and coupled to the second swing arms 34a, 34b, respectively, by attachments 44a, 44b near upper ends of the second swing arms 34a, 34b. The hydraulic cylinders 40a, 40b are controlled by a hydraulic unit 46 mounted in the first casing 14. The hydraulic unit 46 has a pump and valves for controlling the flow of a fluid to and from the hydraulic cylinders 40a, 40b.

As shown in FIG. 1, a dust-resistant, light-shielding bellows 48 which is vertically expandable and contractible is disposed between and connected to the vertically movable base 38 and the first casing 20. As shown in FIG. 1, a top panel 52 that can be displaced in the transverse directions of the first casing 20 indicated by the arrow X and the longitudinal directions thereof indicated by the arrow Y, which are perpendicular to the directions indicated by the arrow X is mounted on the vertically movable base 38.

Two linear touch switches 54 are fixed to the respective longitudinal sides of the top panel 52. Protective covers 56 of synthetic resin are mounted on lower portions of the longitudinal sides of the top panel 52 and positioned outwardly of the touch switches 54. The touch switches 54 are used to turn on and off lock units (not shown) which lock the top panel 52 with respect to the vertically movable base 38. While one of the touch switches 54 is being pressed, the lock units unlock the top panel 52.

As shown in FIG. 2, the vertically movable base 38 supports therein a recording unit 80 for temporarily recording radiation image information of a subject on a stimulable phosphor sheet S. The apparatus housing 14 houses therein a reading unit 82 for photoelectrically reading the image information recorded on the stimulable phosphor sheet S by applying a laser beam L as simulating light to the stimulable phosphor sheet S, an erasing assembly 84 for erasing remaining radiation image information from the stimulable phosphor sheet S after the recorded image information has been read, and a circulating feed system 86 for circulating three stimulable phosphor sheets S, for example, in the image information reading apparatus 10.

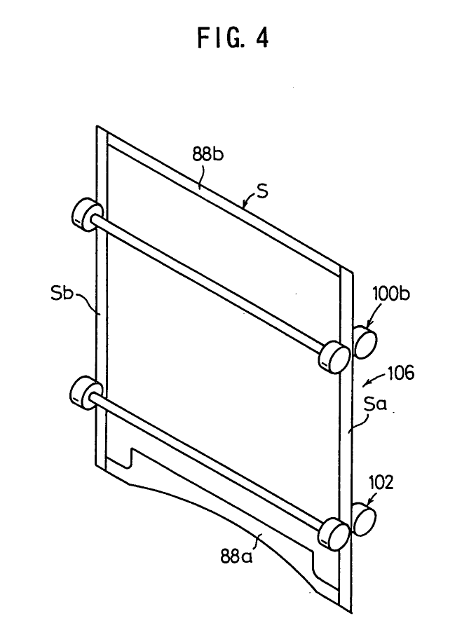

As shown in FIG. 4, the stimulable phosphor sheet S is gripped only at its opposite marginal edges Sa, Sb when it is fed in circulation. Reinforcing plates 88a, 88b are fixed to the reverse side of the stimulable phosphor sheet S.

As shown in FIG. 2, the recording unit 80 has a positioning member 90 for positioning the stimulable phosphor sheet S, and a holder plate 94 swingable about a pivot 92 for holding the stimulable phosphor sheet S in position in the recording unit 80. The circulating feed system 86 has a roller pair 100a disposed near an inlet/outlet end of the recording unit 80 remote from the positioning member 90, and a roller pair 100b spaced a given distance from the roller pair 100a. The roller pairs 100a, 100b are supported on the vertically movable base 38 for vertical movement in unison with the vertically movable base 38.

The circulating feed system 86 also has a plurality of roller pairs 102 disposed in the first casing 20. The second casing 22 houses therein a roller pair 104 which is independent of the circulating feed system 86. The roller pairs 100a, 100b, 102, 104 grip only the marginal edges Sa, Sb of the stimulable phosphor sheet S to feed the stimulable phosphor sheet S.

The circulating feed system 86 comprises a vertical feed path 106 extending vertically downwardly from the recording unit 80, a horizontal feed path 108 extending horizontally from the lower end of the vertical feed path 106 to the roller pair 104, an inclined feed path 110 turning 180° back from the roller pair 104 and extending through the reading unit 82 to a position beyond the erasing assembly 84, and a switchback feed path 112 turning 180° back from the tip end of the inclined feed path 110 for sheet switchback and joined to the vertical feed path 106. The circulating feed system 86 includes a reversible roller pair 114 disposed at the switchback feed path 112.

Three stimulable phosphor sheets S are present in the circulating feed system 86 at all times. These stimulable phosphor sheets S can be placed in three standby positions including a first standby position ST1 as a set position in the recording unit 80, a second standby position ST2 disposed in the horizontal feed path 108, and a third standby position ST3 disposed in the erasing assembly 84.

The reading unit 82 is positioned in the second casing 22. The reading unit 82 comprises an auxiliary scanning feed assembly 120 for feeding a stimulable phosphor sheet S in an auxiliary scanning direction which is a horizontal direction indicated by the arrow A, a laser beam radiating device 122 for applying a laser beam L as stimulating light substantially vertically to the stimulable phosphor sheet S as it is fed in the auxiliary scanning direction to scan the stimulable phosphor sheet S in a main scanning direction which is normal to the auxiliary scanning direction, and first and second light collecting systems 124, 126 for photoelectrically reading light that is emitted from the stimulable phosphor sheet S upon application of the laser beam L.

The auxiliary scanning feed assembly 120 has first and second roller pairs 128, 130 that are rotatable in synchronism with each other. The first light collecting system 124 comprises a first light guide 132a having an end which is disposed at a position where the laser beam L is applied to a recording surface of the stimulable phosphor sheet S and extends in the main scanning direction, and a first photomultiplier 134a mounted on the other end of the first light guide 132a. The second light collecting system 126 comprises a second light guide 132b having an end which is disposed on the side of the reverse surface of the stimulable phosphor sheet S and extends in the main scanning direction, and a second photomultiplier 134b mounted on the other end of the second light guide 132b.

The erasing assembly 84 comprises a first erasing unit 140a disposed over the recording surface of the stimulable phosphor sheet S and a second erasing unit 140b disposed over the reverse surface of the stimulable phosphor sheet S. The first and second erasing units 140a, 140b have respective erasing light sources 142a, 142b.

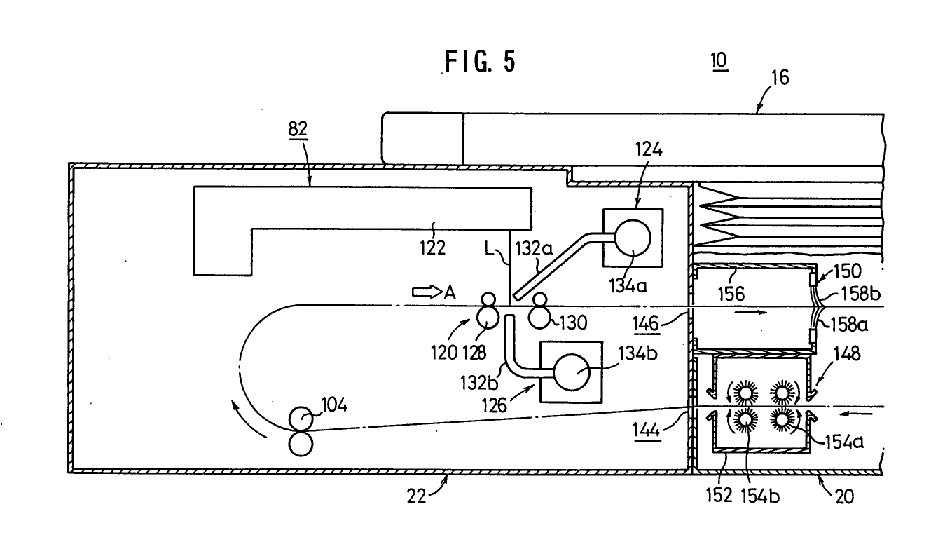

As shown in FIGS. 2 and 5, the first casing 20 and the second casing 22 are individually installed on the floor 12. The first casing 20 houses therein a first cleaning unit 148 and a second cleaning unit 150 which are positioned respectively at an inlet 144 and an outlet 146 that are defined in a wall of the first casing 20. Stimulable phosphor sheets S are introduced from the first casing 20 into the second casing 22 through the inlet 144, and returned from the second casing 22 into the first casing 20 through the outlet 146.

The first cleaning unit 148 comprises a casing 152 fixedly mounted in the first casing 20 and first and second brush roller pairs 154a, 154b disposed in the casing 152. The first and second brush roller pairs 154a, 154b are rotatable in respective opposite directions for scraping dust particles off a stimulable phosphor sheet S that passes through the first cleaning unit 148, between the first and second brush roller pairs 154a, 154b.

The second cleaning unit 150 comprises a casing 156 fixedly mounted in the first casing 20 and a pair of brush members 158a, 158b attached to the casing 156 remotely from the outlet 146 for contacting a stimulable phosphor sheet S that passes through the second cleaning unit 150 to prevent dust particles from entering from the first casing 20 into the casing 156.

As shown in FIG. 1, the controller 24 and the second casing 22 are connected by a cable 164, and the switch unit 26 and the second casing 22 are connected by a cable 168. The second casing 22 has first and second cable ports 166a, 166b defined in respective side panels 22a, 22b of the second casing 22. In FIG. 1, the cable 164 connected to the controller 24 extends through the cable port 166a, and the cable 168 connected to the switch unit 26 extends through the cable port 166b.

The controller 24 has a controller housing 170 and a control table 174 mounted on an upper end of the controller housing 170 and supporting a control panel 172 thereon. The control table 174 can selectively be placed in a plurality of positions with respect to the controller housing 170, e.g., a position shown in FIG. 1 and a position that is 180° spaced from the position shown in FIG. 1. The controller housing 170 houses therein a control unit 176 for controlling the radiation image information reading apparatus 10, and a power supply unit 178 as an external power supply input unit.

The control panel 172 has a plurality of lamps 172a, a display panel 172b, and a plurality of lamps 172c for indicating a recording size with selector keys. When the controller 24 is turned on by the operator who operates console (not shown) or a recording size is selected, the lamps 172a, 172c indicate such turn-on and recording size information, and the display unit 172b displays the ID number and name of a patient registered via the console or a recording menu.

The switch unit 26 has a first foot switch 180 for unlocking the top panel 52 of the imaging bed 16 for horizontal movement thereof, a second foot switch 182 for lowering the imaging bed 16, a third foot switch 184 for lifting the imaging bed 16, and a fourth foot switch 186 for stopping the imaging bed 16 against vertical movement in case of emergency.

An X-ray radiating unit 192 is positioned over the top panel 52.

Operation of the radiation image information reading apparatus 10 thus constructed will be described below.

An ID card carrying ID information of a patient, including an ID number and a name, is prepared, and read by the console. The console selects an imaging area, such as a chest or an abdomen, of the patient, and a recording menu. Then, a recording size is selected, if necessary. Then, the patient as a subject to be imaged is placed on the imaging bed 16.

At this time, the vertical position of the imaging bed 16 in the direction indicated by arrow Z is adjusted depending on the condition of the patient, the height of the patient, and the carriage, such as a wheelchair, a stretcher, or the like, by which the patient has been carried. Specifically, the operator presses the second foot switch 182 to cause the hydraulic unit 46 of the lifting/lowering mechanism 18 to operate the hydraulic cylinders 40a, 40b (see FIG. 3). The rods 42a, 42b of the hydraulic cylinders 40a, 40b are retracted to swing the second swing arms 34a, 34b, which are coupled to the rods 42a, 42b by the attachment 44a, 44b, downwardly about the pivot shafts 32a, 32b.

Since the first swing arms 30a, 30b are coupled to the second swing arms 34a, 34b by the joint shafts 36a, 36b, when the second swing arms 34a, 34b are turned downwardly, the first swing arms 30a, 30b are angularly moved downwardly about the pivot shafts 28a, 28b. Therefore, the vertically movable base 38 is moved downwardly to lower the imaging bed 16.

When the operator presses the third foot switch 184, the hydraulic unit 46 actuates the hydraulic cylinders 40a, 40b in the opposite direction. Therefore, the vertically movable base 38 supported by the first swing arms 30a, 30b and the second swing arms 34a, 34b is elevated, thus lifting the imaging bed 16.

In this manner, the imaging bed 16 is adjusted to a vertical position where the patient can easily be placed onto the top panel 52. After the patient is placed on the top panel 52 with the back or one side down, the operator selectively presses the second foot switch 182 or the third foot switch 184 to adjust the vertical position of the top panel 52 for easy subsequent imaging operation. The operator further presses the first foot switch 180 or continuously turns on one of the touch switches 54 on the top panel 52 to unlock the top panel 52.

With the touch switch 54 being continuously pressed, the operator slides the top panel 52 in the directions indicated by the arrows X, Y to adjust the position of the patient until the imaging area of the patient enters a radiating range of the X-ray radiating unit 192. After the imaging area of the patient is positioned, the operator releases the touch switch 54 to lock the top panel 52 against movement.

The X-ray radiating unit 192 is then energized to record radiation image information of the patient on a stimulable phosphor sheet S in the recording unit 80. At this time, the other two stimulable phosphor sheets S are placed in the second and third standby positions ST2, ST3, respectively.

When the roller pair 100a of the circulating feed system 86 is rotated, the stimulable phosphor sheet S which has recorded the radiation image information is gripped at its marginal edges Sa, Sb by the roller pair 100a and removed from the recording unit 80. The stimulable phosphor sheet S is then gripped by the roller pairs 100b, 102 and transferred from the vertical feed path 106 into the horizontal feed path 108 (see FIG. 4). Then, the stimulable phosphor sheet S is fed from the first casing 20 into the second casing 22 by the roller pairs 102, and turned 180° above the horizontal feed path 108 by the roller pair 104 and fed into the auxiliary scanning feed assembly 120 of the reading unit 82.

In the auxiliary scanning feed assembly 120, the first and second roller pairs 128, 130 are synchronously rotated by a motor (not shown). The stimulable phosphor sheet S is gripped at its marginal edges Sa, Sb by the first and second roller pairs 128, 130 and fed in the auxiliary scanning direction indicated by the arrow A. At this time, the laser beam L is emitted from the laser beam radiating device 122 and applied to the recording surface of the stimulable phosphor sheet S to scan the stimulable phosphor sheet S in the main scanning direction.

When irradiated by the laser beam L, the recording surface of the stimulable phosphor sheet S emits light which represents the recorded radiation image information. The emitted light is photoelectrically read by the first light collecting system 124. Light that has passed through a transparent base of the stimulable phosphor sheet S is emitted from the reverse surface thereof, and photoelectrically read by the second light collecting system 126.

The stimulable phosphor sheet S, from which the recorded radiation image information has been read, is fed from the second casing 22 back into the first casing 20, and delivered along the inclined feed path 110 into the erasing assembly 84. In the erasing assembly 84, the erasing light sources 142a, 142b of the first and second erasing units 140a, 140b apply erasing light to the both surfaces of the stimulable phosphor sheet S to erase unwanted remaining radiation image information from the stimulable phosphor sheet S.

After the remaining radiation image information has been erased from the stimulable phosphor sheet S, the stimulable phosphor sheet S is turned 180° below the inclined feed path 110 and delivered into the switchback feed path 112. The roller pair 114 on the switchback feed path 112 is reversed to feed the stimulable phosphor sheet S from the switchback feed path 112 into the vertical feed path 106, along which the stimulable phosphor sheet S is delivered by the roller pairs 100a, 100b into the recording unit 80.

In the present embodiment, the apparatus housing 14 and the controller 24, which are separate from each other, can be installed suitably in a desired layout pattern in a hospital, for example.

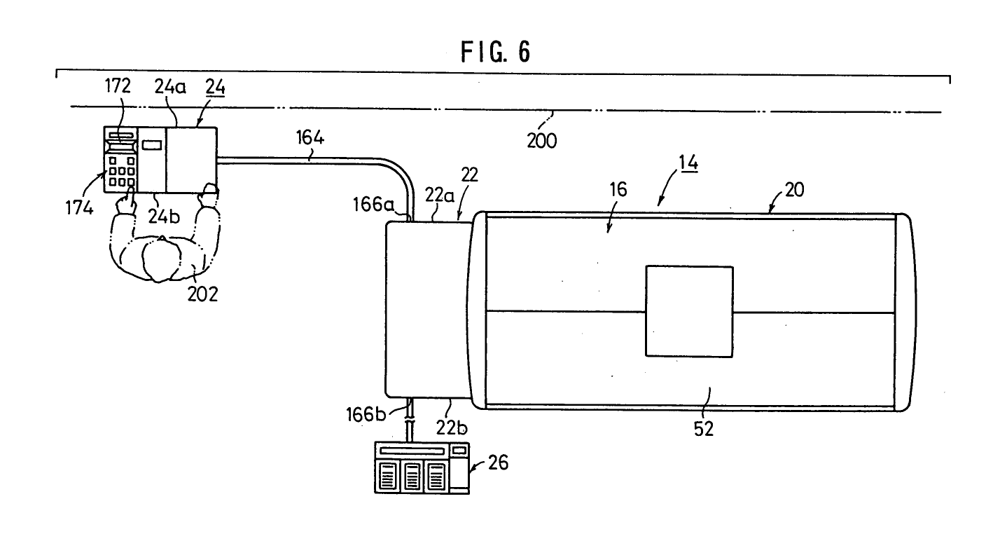

For example, as shown in FIG. 6, if the radiation image information reading apparatus 10 is to be installed along a wall 200 in a hospital, then the cable 164 connected to the controller 24 is extended through the first cable port 166a defined in the side 22a of the second casing 22, and the cable 168 connected to the switch unit 26 is extended through the second cable port 166b defined in the side 22b of the second casing 22.

The controller 24 has its side 24a disposed closely to the wall 200, and the control table 174 is oriented such that the control panel 172 can be operated by the operator 202 at an opposite side 24b of the controller 24. Therefore, the operator 202 can operate the control panel 172 at the side 24b of the controller 24, and is not obstructed by the cable 164 connected to the controller 24.

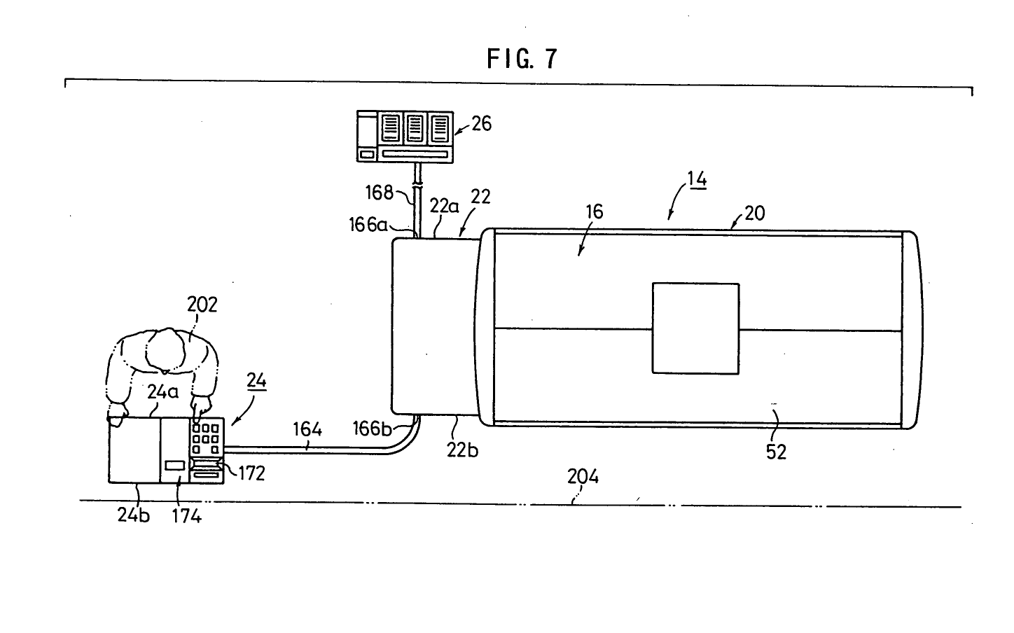

If the radiation image information reading apparatus 10 is to be installed along a wall 204, as shown in FIG. 7, then the cable 164 connected to the controller 24 is extended through the second cable port 166b defined in the side 22b of the second casing 22, and the cable 168 connected to the switch unit 26 is extended through the first cable port 166a defined in the side 22a of the second casing 22.

The controller 24 has its side 24b disposed closely to the wall 204, and the control table 174 is turned 180° from the position shown in FIG. 6. Therefore, the operator 202 can operate the control panel 172 at the side 24a of the controller 24, and is not obstructed by the cable 164 connected to the controller 24. Thus, the operator 202 can handle and operate the radiation image information reading apparatus 10 with ease.

As described above, the cable 164 connected to the controller 24 can selectively be extended through the first and second cable ports 166a, 166b defined in the sides 22a, 22b of the second casing 22. Consequently, the apparatus housing 14 and the controller 24 can effectively be installed according to a desired layout pattern in a hospital, for example, without the cable 164 presenting an obstacle to motions of the operator 202 and the patient. Accordingly, the apparatus housing 14 and the controller 24 can effectively be installed according to various layout patterns.

The control table 174 on the controller housing 170 of the controller 24 can selectively be placed in a plurality of positions with respect to the controller housing 170, e.g., 180°-spaced positions. Therefore, even if the installation of the controller 24 is restricted to a certain limited position due to the connection of the cable 164, one of the selectable positions of the control table 174 may be selected for better operation of the controller 24. Accordingly, the radiation image information reading apparatus 10 can be installed to meet various layout requirements in certain facilities such as hospitals.

Since the apparatus housing 14 and the controller 24 are separate from each other, the apparatus housing 14 takes up a reduced installation space, and the minimum height of the imaging bed 16 can be reduced. For placing the patient onto the top panel 52, the vertical position of the imaging bed 16 can be adjusted to allow the patient to be placed onto the top panel 52 with ease depending on the condition and/or height of the patient and the carriage, e.g., a wheelchair or a stretcher, by which the patient has been delivered.

Even if the patient is of a small height, the operator is not required to use a step, and can easily and smoothly transfer the patient from a wheelchair or a stretcher to the top panel 52. As a consequence, the operator can efficiently place the patient onto or off the top panel 52, with a greatly reduced physical and mental burden on the patient or the operator or both.

The first casing 20 and the second casing 22 are separate from each other, and the second casing 22 houses only the reading unit 82. Therefore, the reading unit 82 is securely isolated from the recording unit 80, the lifting/lowering mechanism 18, the erasing assembly 84, and the circulating feed system 86. When the first casing 20 and the second casing 22 are individually installed on the floor 12, the reading unit 82 is isolated from vibrations from the lifting/lowering mechanism 18 and the circulating feed system 86 and vibrations that are produced when the patient climbs on and off the imaging bed 16. In the reading unit 82, consequently, the stimulable phosphor sheet S can be fed accurately in the auxiliary scanning direction indicated by the arrow A for an increased accuracy with which to read the radiation image information recorded on the stimulable phosphor sheet S.

The inlet 144 and the outlet 146 of the second casing 22 are associated with the first cleaning unit 148 and the second cleaning unit 150, respectively. When the stimulable phosphor sheet S is fed from the first casing 20 into the second casing 22, both surfaces of the stimulable phosphor sheet S are contacted by the first and second brush roller pairs 154a, 154b that are rotated in the opposite directions in the casing 152 (see FIG. 5) of the first cleaning unit 148. At this time, dust attached to the stimulable phosphor sheet S is reliably scraped off by the first and second brush roller pairs 154a, 154b, and hence prevented from being carried into the second casing 22 by the stimulable phosphor sheet S.

When the stimulable phosphor sheet S from which the radiation image information has been read is fed from the second casing 22 into the first casing 20, the stimulable phosphor sheet S is contacted by the brush members 158a, 158b in the casing 156 of the second cleaning unit 150. When no stimulable phosphor sheet S passes between the brush members 158a, 158b, the brush members 158a, 158b contact each other to prevent dust particles from entering from the first casing 20 into the casing 156 and hence the second casing 22.

Therefore, dust particles are prevented from entering the reading unit 82, and no dust is attached to the stimulable phosphor sheet S from which the recorded radiation image information is being read by the reading unit 82. Thus, the radiation image information read from the stimulable phosphor sheet S is prevented from suffering faults, and hence a highly accurate image can efficiently be obtained from the radiation image information read from the stimulable phosphor sheet S.

In the illustrated embodiment, the first and second cable ports 166a, 166b are defined in the respective side panels 22a, 22b of the second casing 22. However, three or more cable ports may be defined in the second casing 22, or cable ports may be defined in an end wall of the second casing 22.

The built-in radiation image information reading apparatus 10 with stimulable phosphor sheets S being circulated in the apparatus housing 14 has been described above. However, the principles of the present invention are also applicable to a radiation image information reading apparatus of the type where a stimulable phosphor sheet S is loaded via a cassette or a magazine.

In the radiation image information reading apparatus according to the present invention, at least two cable ports for selectively extending the cable connected to the controller are defined in the housing of the apparatus. By selecting these cable ports, the radiation image information reading apparatus can be installed effectively in one of various available layout patterns to allow the operator to operate the radiation image information reading apparatus with high efficiency without being obstructed by the cable.

The radiation image information reading apparatus has the first casing which houses at least the erasing unit and the feed system and the second casing separate from the first casing and housing the reading unit. Therefore, the reading unit is effectively separate from the erasing unit and the feed system. This arrangement is effective to prevent dust particles from entering from the first casing into the reading unit, and also to prevent vibrations of the feed systems from being transmitted to the reading unit. As a result, the radiation image information recorded on the stimulable phosphor sheet can efficiently and reliably be read with high accuracy.

Although a certain preferred embodiment of the present invention has been shown and described in detail, it should be understood that various changes and modifications may be made therein without departing from the scope of the appended claims.

1.-6. (canceled)

7. A radiation image information reading apparatus comprising:
a reading unit for applying stimulating light to a stimulable phosphor sheet with radiation image information recorded thereon to photoelectrically read the radiation image information from said stimulable phosphor sheet;
an erasing assembly for erasing remaining radiation image information from the stimulable phosphor sheet after the recorded radiation image information is read from the stimulable phosphor sheet;
a feed system for feeding said stimulable phosphor sheet;
a first casing housing said feed system and said erasing assembly therein; and
a second casing housing said reading unit therein, said second casing being separate from said first casing.

8. A radiation image information reading apparatus according to claim 7, further comprising:
cleaning means disposed in said first housing for cleaning said stimulable phosphor sheet, said cleaning means being associated with an inlet or an outlet through which said stimulable phosphor sheet passes into or from said second casing.

9. A radiation image information reading apparatus according to claim 7, wherein said first casing and said second casing are individually mounted on an installation surface.
